(19) United States
(12) Patent Application Publication
(10) Pub. No.: US 2019/0315162 A1
(43) Pub. Date: Oct. 17, 2019

(54) PNEUMATIC TIRE

(71) Applicant: TOYO TIRE CORPORATION, Itami-shi (JP)

(72) Inventor: Kouichi Takita, Itami-shi (JP)

(73) Assignee: TOYO TIRE CORPORATION, Itami-shi (JP)

(21) Appl. No.: 16/367,636

(22) Filed: Mar. 28, 2019

(30) Foreign Application Priority Data
Apr. 11, 2018 (JP) 2018-075873

(51) Int. Cl. B60C 13/02

(52) U.S. Cl. CPC B60C 13/02; B60C 2200/14

(57) ABSTRACT

A pneumatic tire has a protrusion provided on a buttress portion. The protrusion includes a side wall protruding from a surface of the buttress portion, and a top wall provided at a distal end of the side wall. At least one of a pair of portions included in the side wall and facing each other in a tire circumferential direction constitutes a protruding curve as viewed in a tire width direction.

### CROSS-REFERENCE TO RELATED APPLICATIONS

This application claims priority of Japanese Patent Application No.: 2018-75873 filed on Apr. 11, 2018, the content of which is incorporated herein by reference.

### BACKGROUND OF THE INVENTION

### Technical Field

The present invention relates to a pneumatic tire.

### Related Art

A pneumatic tire which includes protrusions on a buttress portion is known (see JP 2013-82262 A and JP 2015-168301 A). Generally, protrusions of this type are provided to improve traction performance during traveling on rough unpaved roads or bad roads such rocky roads.

### SUMMARY

Modes known as external damage or failure caused during traveling on bad roads include a tear of the buttress portion at bases of the protrusions.

There is still room for improvement, however, over protrusions provided in buttress portions of conventional pneumatic tires, including those disclosed in JP 2013-82262 A and JP 2015-168301 A, for increasing external damage resistance of the protrusions while securing traction performance.

An object of the present invention is to improve external damage resistance of protrusions provided in a buttress portion of a pneumatic tire while securing traction performance.

One aspect of the present invention provides a pneumatic tire including a protrusion provided on a buttress portion. The protrusion includes a side wall protruding from a surface of the buttress portion, and a top wall provided at a distal end of the side wall. At least one of a pair of portions included in the side wall and facing each other in a tire circumferential direction constitutes a protruding curve as viewed in a tire width direction.

The protrusion provided on the buttress portion improves traction performance.

One of the pair of portions included in the side wall of the protrusion and facing each other in the tire circumferential direction constitutes a protruding curve as viewed in the tire width direction, and comes to the kicking side. In this case, external damage resistance improves. More specifically, in the configuration that the side wall forms a protruding curve as viewed in the tire width direction, a ground contact length in the tire radial direction gradually decreases toward a kicking side end of the protrusion. Accordingly, movement of the protrusion at the time of kicking decreases. As a result, external damage resistance of the protrusion improves.

The side wall may have a cylindrical shape. The top wall may have a circular shape as viewed in the tire width direction.

The side wall may have a track-shaped elliptically cylindrical shape. The top wall may have a track-shaped elliptical shape as viewed in the tire width direction.

The side wall may have an elliptically cylindrical shape. The top wall may have an elliptical circular shape as viewed in the tire width direction.

The protrusion may have a semispherical shape. Each of the side wall and the top wall may be a part of the semispherical shape.

The protrusion may have a semi-elliptically spherical shape. Each of the side wall and the top wall may be a part of the semi-elliptically circular shape.

According to a following constitution, the side wall of the protrusion is symmetric with respect to an extending axis. In this case, each of the pair of portions included in the side wall and facing each other in the tire circumferential direction constitutes a protruding curve as viewed in the tire width direction. In this case, movement of the protrusion at the time of kicking decreases in each of the two rotation directions of the pneumatic tire. Accordingly, external damage resistance of the protrusion improves.

One of the pair of portions of the side wall may be a part of a cylindrical shape. The other of the pair of portions may have a flat shape that extends while crossing the tire circumferential direction.

One of the pair of portions of the side wall may be a curved surface portion having a track-shaped elliptically cylindrical shape. The other of the pair of portions may have a flat shape that extends while crossing the tire circumferential direction.

One of the pair of portions of the side wall may be a part of an elliptically cylindrical shape. The other of the pair of portions may have a flat shape that extends while crossing the tire circumferential direction.

One of the pair of portions of the side wall may be a part of a semispherical shape. The other of the pair of portions may have a flat shape that extends while crossing the tire circumferential direction.

One of the pair of portions of the side wall may be a part of a semi-elliptically spherical shape. The other of the pair of portions may have a flat shape that extends while crossing the tire circumferential direction.

According to a following constitution, one of the pair of portions included in the side and facing each other in the tire circumferential direction constitutes a flat shape. This portion and the top wall define a linear edge as viewed in the tire width direction. Accordingly, traction performance further improves by setting the rotation direction of the pneumatic tire such that the portion constituting the pair of portions of the side wall and having the flat shape comes to a treading side. In addition, in case of this setting of the rotation direction, the portion constituting the pair of portions of the side wall and not having a flat shape comes to the kicking side. Accordingly, external damage resistance improves by reduction of movement of the protrusion at the time of kicking.

Each of an outer end and an inner end of the protrusion in the fire radial direction is disposed at a height in a range not less than 0.1 and not more than 1.0 times a tire height from an innermost end of the pneumatic tire.

The pneumatic tire may include a block that extends from the tread portion to the buttress portion beyond a tread end. The protrusion may be disposed such that an outer end of the protrusion is disposed adjacent to an inner end of the block in the tire radial direction.

The block may include a first block having an edge that is defined by a portion extending in the tire width direction and a portion extending in the tire radial direction, and that is located at a first position. The block may include a second block having an edge that is defined by a portion extending in the tire width direction and a portion extending in the tire radial direction, and that is located at a second position closer to a center in the tire width direction than the first position is. The first block and the second block may be alternately arranged in the tire circumferential direction.

A step is formed in the tire circumferential direction by the edge of the first block and the edge of the second block. Traction performance further improves by cooperative operation of the first and second blocks forming this step, and the protrusion.

According to the present invention, external damage resistance of a protrusion provided on a buttress portion of a pneumatic tire improves while securing traction performance.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to a first embodiment of the present invention;

FIG. 2 is a partial developed view of a tread portion and a buttress portion of the pneumatic tire according to the first embodiment of the present invention;

FIG. 3 is a partial side view of the buttress portion according to the first embodiment of the present invention;

FIG. 4A is a perspective view of a protrusion according to the first embodiment of the present invention;

FIG. 4B is a view of the protrusion according to the first embodiment of the present invention as viewed in a tire width direction;

FIG. 5A is a perspective view of a protrusion according to a modified example of the first embodiment of the present invention;

FIG. 5B is a view of the protrusion according to the modified example of the first embodiment of the present invention as viewed in the tire width direction;

FIG. 6A is a perspective view of a protrusion according to a second embodiment of the present invention;

FIG. 6B is a view of the protrusion according to the second embodiment of the present invention as viewed in the tire width direction;

FIG. 7A is a perspective view of a protrusion according to a modified example of the second embodiment of the present invention;

FIG. 7B is a view of the protrusion according to the modified example of the second embodiment of the present invention as viewed in the tire width direction;

FIG. 8A is a perspective view of a protrusion according to a third embodiment of the present invention;

FIG. 8B is a view of the protrusion according to the third embodiment of the present invention as viewed in the tire width direction;

FIG. 9A is a perspective view of a protrusion according to a modified example of the third embodiment of the present invention;

FIG. 9B is a view of the protrusion according to the modified example of the third embodiment of the present invention as viewed in the tire width direction;

FIG. 10A is a perspective view of a protrusion according to a fourth embodiment of the present invention;

FIG. 10B is a view of the protrusion according to the fourth embodiment of the present invention as viewed in the tire width direction;

FIG. 11A is a perspective view of a protrusion according to a modified example of the fourth embodiment of the present invention;

FIG. 11B is a view of the protrusion according to the modified example of the fourth embodiment of the present invention as viewed in the tire width direction;

FIG. 12A is a perspective view of a protrusion according to a fifth embodiment of the present invention;

FIG. 12E is a view of the protrusion according to the fifth embodiment of the present invention as viewed in the tire width direction;

FIG. 13A is a perspective view of a protrusion according to a modified example of the fifth embodiment of the present invention; and

FIG. 13B is a view of the protrusion according to the modified example of the fifth embodiment of the present invention as viewed in the tire width direction.

### DETAILED DESCRIPTION OF EMBODIMENTS

An embodiment of the present invention is hereinafter described with reference to the accompanying drawings. It should be noted that the following description is essentially presented by way of example, and not intended to limit the present invention, applicable ranges of the present invention, or purposes of use of the present invention. In addition, the accompanying drawings are only schematic figures, and do not show actual ratios or the like of respective dimensions.

In each of the figures, an X direction corresponds to a tire radial direction, a Y direction corresponds to a tire circumferential direction, and a Z direction corresponds to a tire width direction.

### First Embodiment

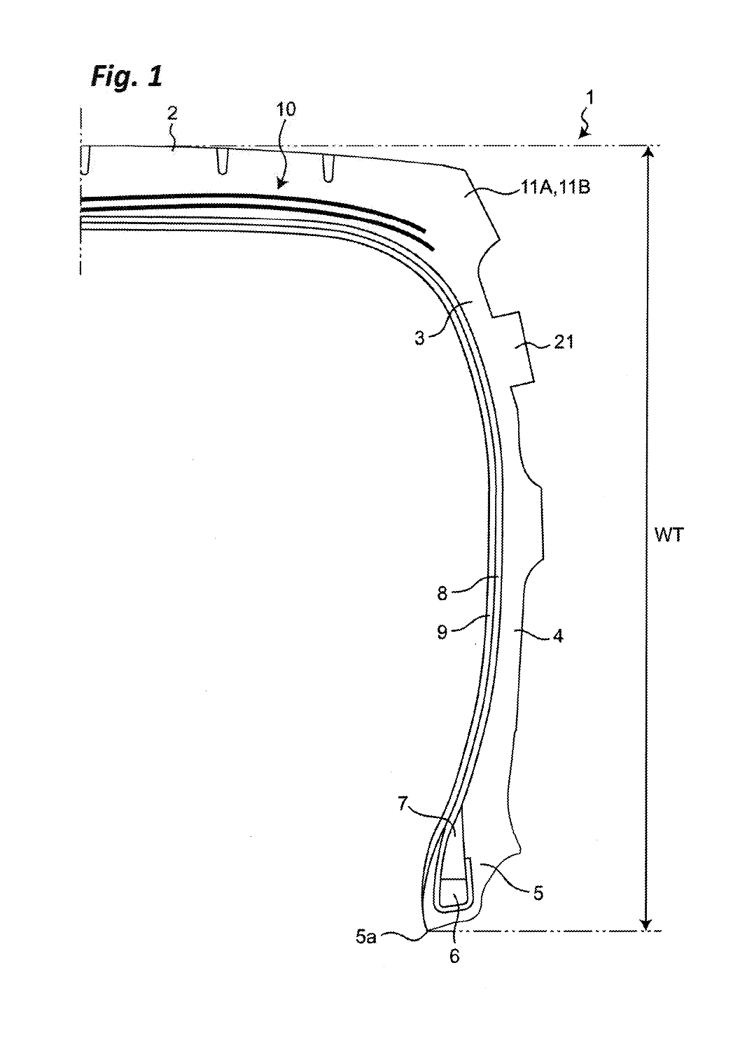

Referring to FIG. 1, a pneumatic tire 1 includes a tread portion 2, a pair of sidewall portions 4 extending from both ends of the tread portion 2 in the tire width direction toward the inside in the tire radial direction via buttress portions 3 as transition regions, and a pair of bead portions 5 disposed at inner ends of the pair of sidewall portions 4 in the tire radial direction. Each of the bead portions 5 includes a bead core 6 having an annular shape, and a bead filler 7 disposed outside the bead core 6 in the tire radial direction.

A carcass plus 8 having a toroidal shape is disposed between the pair of bead portions 5 inside the tread portion 2 and the sidewall portions 4 in the tire radial direction. An inner liner 9 is disposed inside the carcass plus 8 in the tire radial direction. A belt layer 10 is provided in the tread portion 2 outside the carcass plus 8 in the tire radial direction.

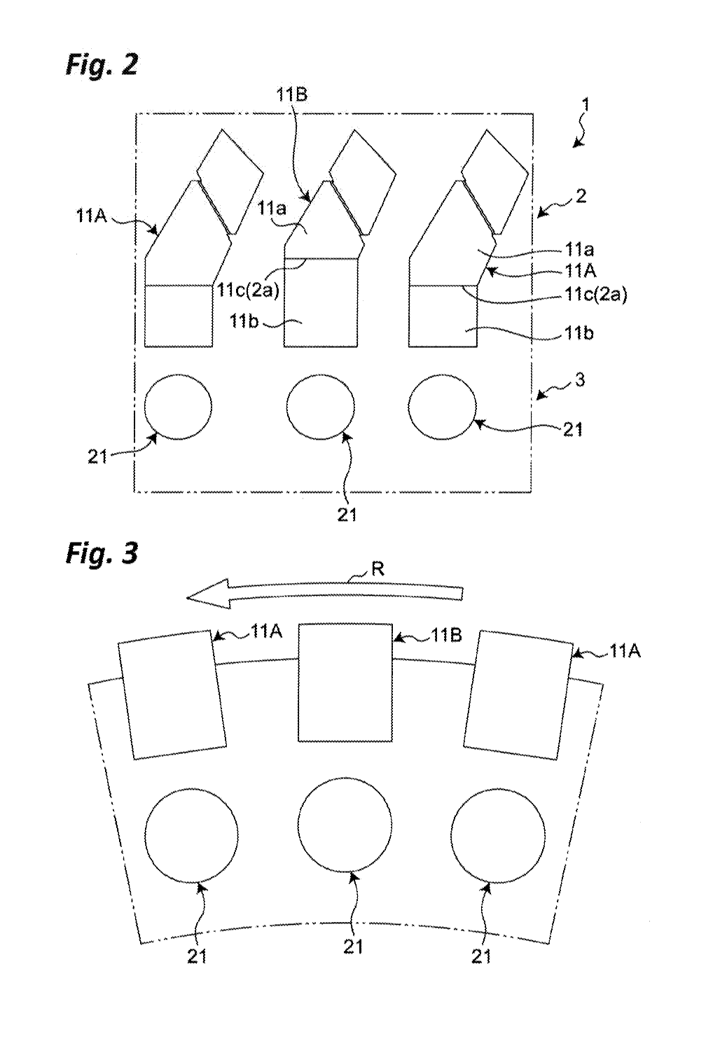

Further referring to FIGS. 2 and 3, blocks 11A and 11B provided in a region outside the tread portion 2 in the tire width direction extend from the tread portion 2 to the buttress portion 3. The blocks 11A and 11B are alternately arranged in the tire circumferential direction. Each of the blocks 11A and 11B includes a portion 11a extending in the tire width direction in the tread portion 2, and a portion 11b extending in the tire radial direction in the buttress portion 3. The respective portions 11a and 11b define an edge 11c. According to the present embodiment, the edge 11c constitutes a tread end 2a.

A position of the edge 11c of the block 11B in the tire width direction (second position) is located closer to the center in the tire width direction than a position of the edge 11c of the block 11A in the tire width direction (first position) is. Accordingly, the edge 11c of the block 11A and the edge 11c of the block portion 11B form repetitive steps in the tire circumferential direction (staggered shoulder structure).

Protrusions 21 protruding in the tire width direction are provided adjacent to the respective blocks 11A and 11B in the buttress portion 3. The position and size of each of the protrusions 21 are not limited to those specified in the present embodiment. More specifically, the position and the size of each of the protrusions 21 may be set such that each of an outer end and an inner end of the protrusion 21 in the tire radial direction is located at a height in a range not less than 0.1 and nor more than 1.0 times a tire height WT from an innermost end 5a of the bead portion 5, which end is an innermost end of the pneumatic tire 1.

The protrusions 21 provided on the buttress portions 3 improve traction performance. Particularly, according to the present embodiment, the protrusions 21 are provided adjacent to the blocks 11A and 11B where the edges 11c farm repetitive steps in the tire circumferential direction as described above. Traction performance effectively improves by cooperative operation of the blocks 11A and 11B forming the steps, and the protrusions 21.

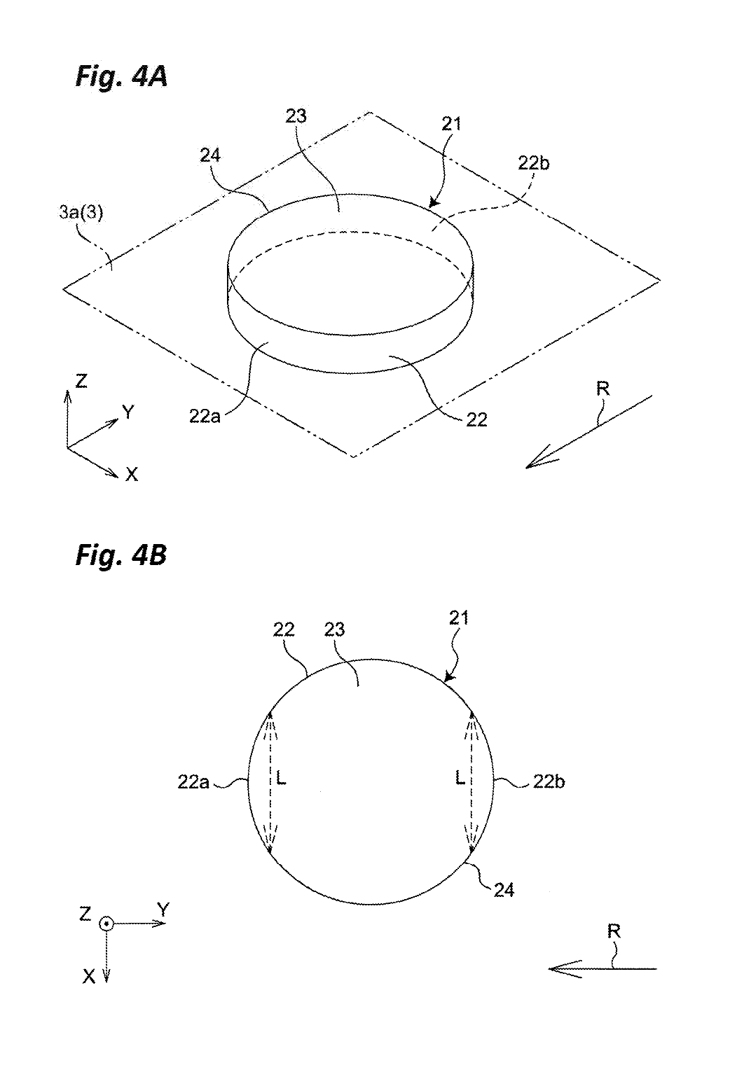

Referring to FIGS. 4A and 4B, the protrusion 21 includes a side wall 22 protruding from a surface 3a of the buttress portion 3 in the tire width direction, and a top wall 23 provided at a distal end of the side wall 22. In case of the protrusion 21 of the present embodiment, the side wall 22 has a cylindrical shape, while the top wall 23 has a circular shape as viewed in the tire width direction. The side wall 22 and the top wall 23 define an edge 24 in a circular shape (example of protruding curve) as viewed in the tire width direction.

According to the present embodiment, the side wall 22 of the protrusion 21 has a cylindrical shape which is symmetric with respect to an axis extending in the tire width direction. In this case, the edge 24 defined by the side wall 22 and the top wall 23 is arcuate as viewed in the tire width direction in each of a pair of portions 22a and 22b included in the side wall 22 and facing each other in the tire circumferential direction. Accordingly, when a rotation direction of the pneumatic tire 1 is a direction indicated by an arrow R in the figure, for example, a ground contact length L of the portion 22b corresponding to a kicking side in the tire radial direction gradually decreases toward a kicking side end of the protrusion 21. In the configuration that the ground contact length L gradually decreases, only an extremely small change of decrease in the ground contact length L is produced from a moment immediately before a ground non-contact state of the top wall 23 on the kicking side to a moment of the ground non-contact state. Accordingly, movement of the protrusion 21 at the time of kicking decreases. According to knowledge of the present inventor, failure or external damage of the protrusion provided in the buttress portion is chiefly produced as a crack at a boundary between the side portion on the kicking side and the surface of the buttress portion. Particularly a crack produced at the boundary between the side portion 22b on the kicking side and the surface 3a of the buttress portion 3 can be effectively prevented by reducing movement of the protrusion 21 at the time of kicking. Accordingly, external damage resistance of the protrusion 21 improves.

When the rotation direction of the pneumatic tire 1 is opposite to the direction indicated by the arrow R, the ground contact length L of the portion 22a of the side wall 22 in the tire radial direction on the kicking side also gradually decreases toward the kicking side end of the protrusion 21. Accordingly, movement of the protrusion 21 at the time of kicking decreases, and therefore external damage resistance of the protrusion 21 improves. More specifically, the side wall 22 of the protrusion 21 of the present embodiment is cylindrical and symmetric with respect to the axis extending in the tire width direction as described above. Accordingly, movement of the protrusion 21 decreases at the time of kicking, and external damage resistance of the protrusion 21 improves in each of the two rotation directions of the pneumatic tire 1 (direction of arrow R and opposite direction).

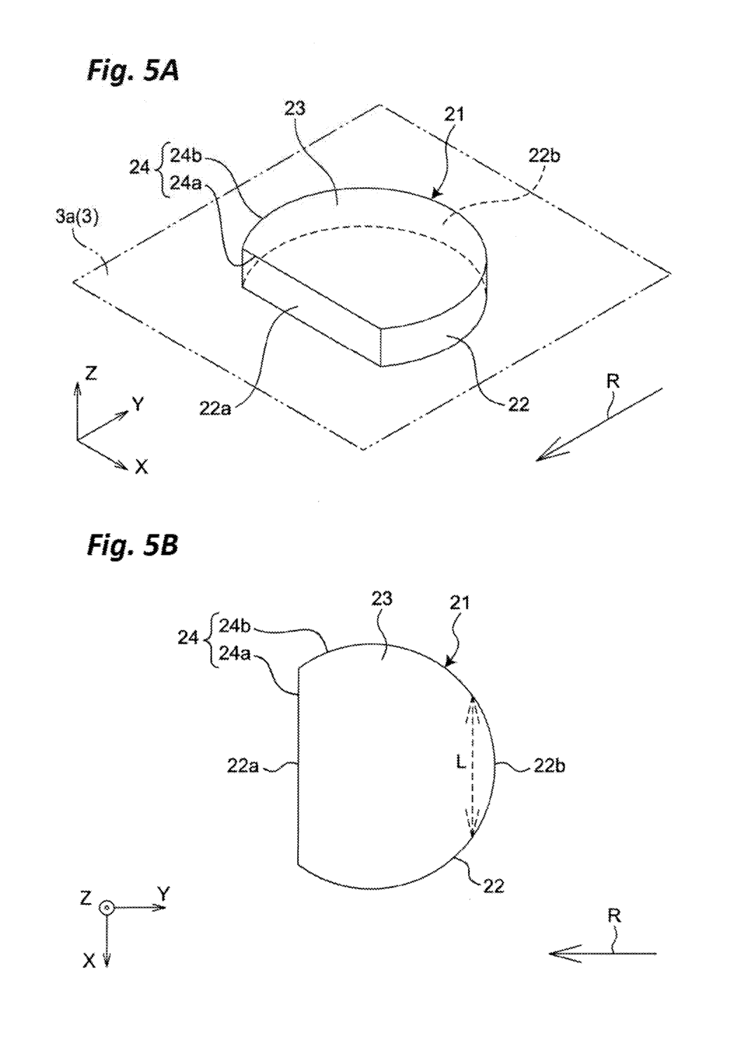

FIGS. 5A and 5B show the protrusion 21 according to a modified example of the first embodiment. According to the protrusion 21 in this example, the side wall 22 includes the pair of portions 22a and 22b facing each other in the tire circumferential direction. The one portion 22b is a part of a cylindrical shape, while the other portion 22a is a flat surface extending while crossing the tire circumferential direction and the surface 3a of the buttress portion 3 at right angles. The edge 24 defined by the side wall 22 and the top wall 23 has an edge 24a which is defined by the portion 22a of the side wall 22 corresponding to a fiat surface, and by the top wall 23, and has a linear shape extending in the tire radial direction as viewed in the tire width direction, and an edge 24b which is defined by the other part of the side wall 22 and by the top wall 23 and has an arcuate shape.

When the rotation direction of the pneumatic tire 1 is the direction indicated by the arrow R, the portion 22a of the side wall 22 corresponding to the flat surface, i.e., the edge 24a having a linear shape comes to the treading side. Accordingly, traction performance further improves. In this case, the portion 22b of the side wall 22 constituting a part of the cylindrical shape serves as the kicking side. Accordingly, movement of the protrusion 21 at the time of kicking decreases, and therefore external damage resistance improves.

Second to fifth embodiments of the present invention will be hereinafter described. Structures, actions, and functions not particularly mentioned in the following embodiments are similar to those of the first embodiment. In addition, elements identical or similar to the corresponding elements of the first embodiment are given identical reference numbers, and the description and figures relating to these elements of the first embodiment will be also referred to.

### Second Embodiment

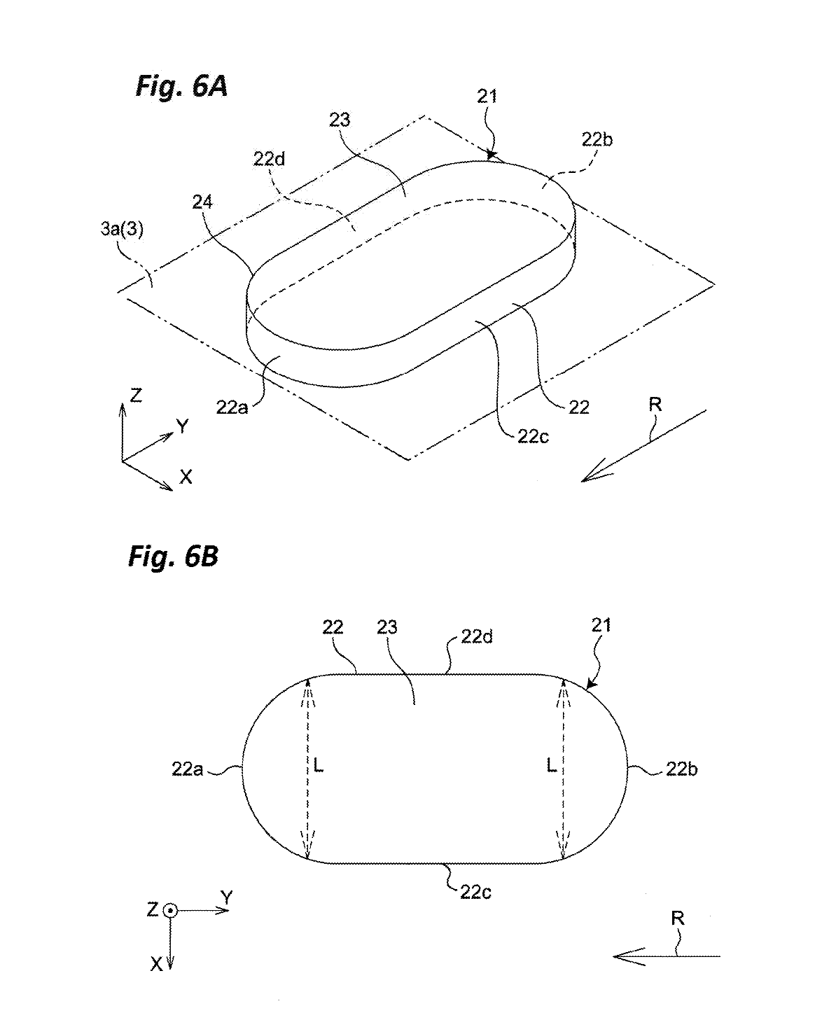

FIGS. 6A and 6B show the protrusion 21 according to the second embodiment of the present invention. In case of the protrusion 21 in this example, the side wall 22 has a track-shaped elliptically cylindrical shape, while the top wall 23 has a track-shaped elliptical shape as viewed in the tire width direction. Each of the pair of portions 22a and 22b included in the side wall 22 and facing each other in the tire circumferential direction is a curved surface portion having a track-shaped elliptically cylindrical shape. Portions 22c and 22d each constituted by a flat surface (linear as viewed in the tire width direction) are provided between the portions 22a and 22b of the side wall 22.

The edge 24 defined by the top wall 23 and each of the pair of portions 22a and 22b included in the side wall 22 of the protrusion 21 and facing each other in the tire circumferential direction has an arcuate shape (example of protruding curve). Accordingly, the ground contact length L in the tire radial direction gradually decreases toward the kicking side end of the protrusion 21 in either the case where the rotation direction of the pneumatic tire 1 is the direction indicated by the arrow R or the case where the rotation direction of the pneumatic tire is the direction opposite to the arrow R, i.e., in either the case where the portions 22a is located on the kicking side or the case where the portion 22b is located on the kicking side. Accordingly, movement of the protrusion 21 at the time of kicking decreases. As a result, external damage resistance of the protrusion 21 improves.

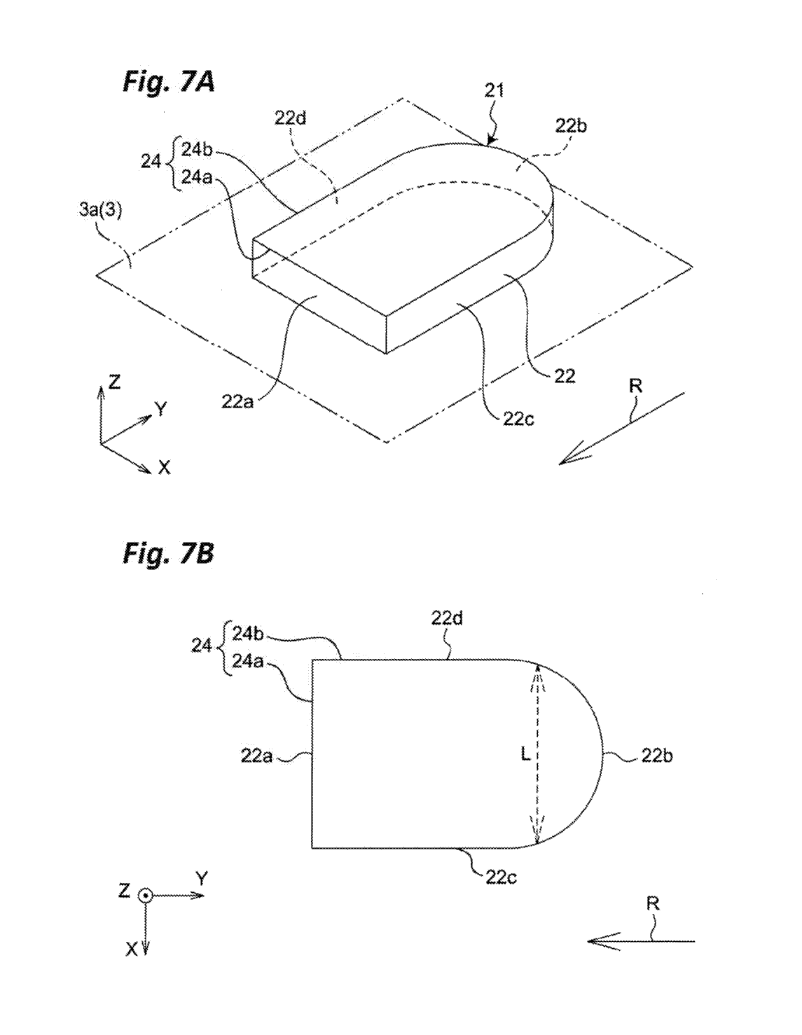

FIGS. 7A and 7B show the protrusion 21 according to a modified example of the second embodiment. According to the protrusion 21 in this example, the side wall 22 includes the pair of portions 22a and 22b facing each other in the tire circumferential direction. The one portion 22b is a part of a curved surface having a track-shaped elliptically cylindrical shape, while the other portion 22a is a flat surface extending while crossing the tire circumferential direction and the surface 3a of the buttress portion 3 at right angles. The edge 24 defined by the side wall 22 and the top wall 23 has the edge 24a defined by the portion 22a of the side wall 22 corresponding to a flat surface, and by the top wall 23, and having a linear shape extending in the tire radial direction as viewed in the tire radial direction, and the edge 24b defined by the other part of the side wall 22 and by the top wall 23.

When the rotation direction of the pneumatic tire 1 is the direction indicated by the arrow R, the portion 22a of the side wall 22 corresponding to the flat surface, i.e., the edge 24a having a linear shape comes to the treading side. Accordingly, traction performance further improves. In this case, the portion 22b of the side wall 22 constituted by a curved surface is located on the kicking side. Accordingly, external damage resistance improves by reduction of movement of the protrusion 21 at the time of kicking.

### Third Embodiment

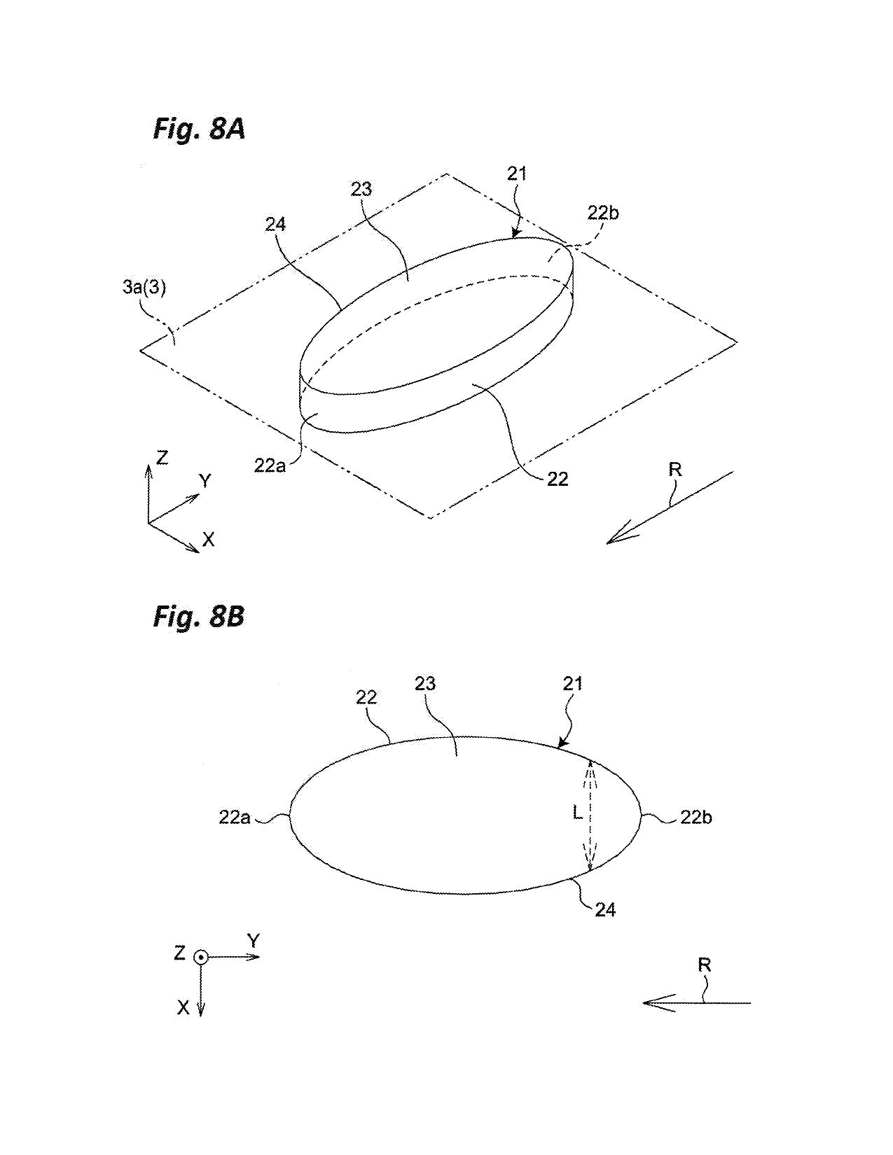

FIGS. 8A and 8B show the protrusion 21 according to a third embodiment of the present invention. In case of the protrusion 21 in this example, the side wall 22 has an elliptically cylindrical shape, while the top wall 23 has an elliptical shape as viewed in the tire width direction. Each of the pair of portions 22a and 22b included in the side wall 22 and facing each other in the tire circumferential direction is a part of an elliptically cylindrical shape.

The edge 24 defined by the top wall 23 and each of the pair of portions 22a and 22b included in the side wall 22 of the protrusion 21 and facing each other in the tire circumferential direction has an elliptically arcuate shape (example of protruding curve). Accordingly, the ground contact length L in the tire radial direction gradually decreases toward the kicking side end of the protrusion 21 in either the case where the rotation direction of the pneumatic tire 1 is the direction indicated by the arrow R or the case where the rotation direction of the pneumatic tire is the direction opposite to the arrow R, i.e., in either the case where the portions 22a is located on the kicking side or the case where the portion 22b is located on the kicking side. Accordingly, movement of the protrusion 21 at the time of kicking decreases. As a result, external damage resistance of the protrusion 21 improves.

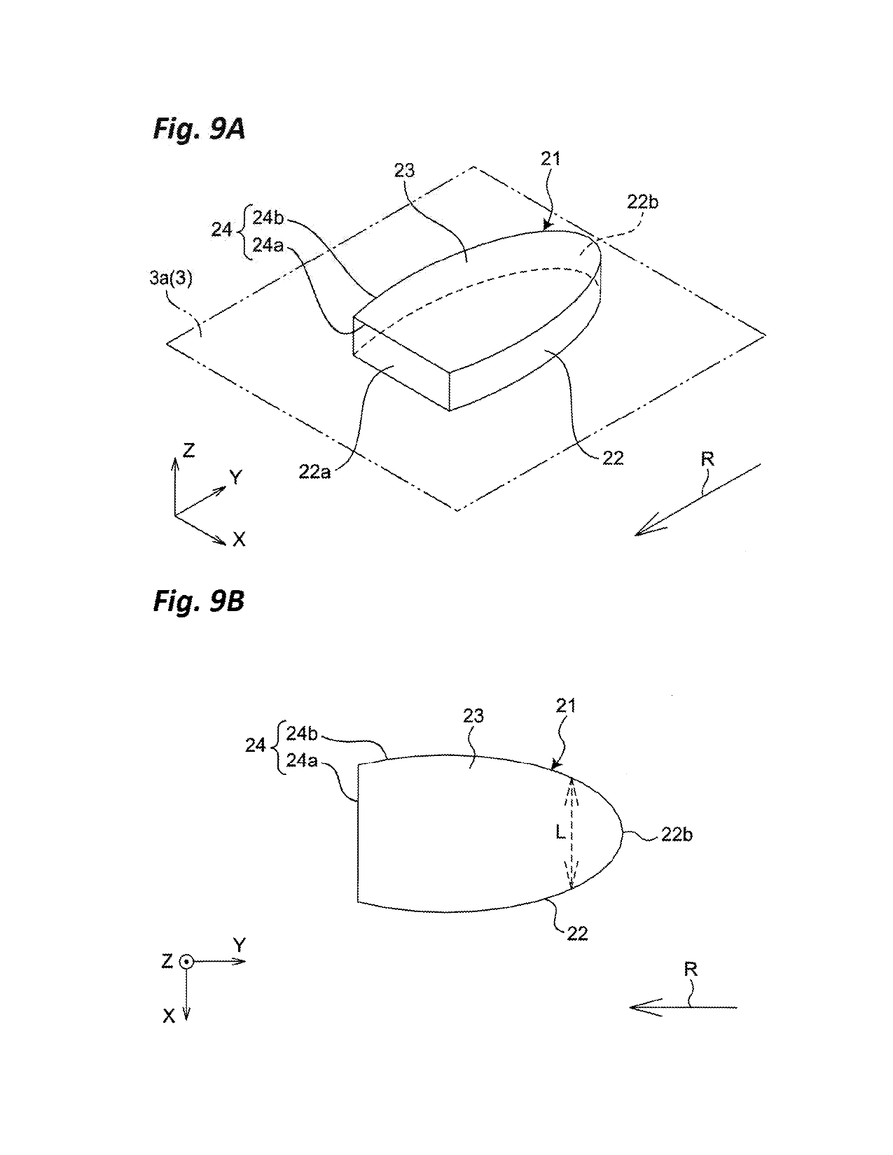

FIGS. 9A and 9B show the protrusion 21 according to a modified example of the third embodiment. According to the protrusion 21 in this example, the side wall 22 includes the pair of portions 22a and 22b facing each other in the tire circumferential direction. The one portion 22b is a part of an elliptically cylindrical shape, while the other portion 22a is a flat surface extending while crossing the tire circumferential direction and the surface 3a of the buttress portion 3 at right angles. The edge 24 defined by the side wall 22 and the top wall 23 has an edge 24a which is defined by the portion 22a of the side wall 22 corresponding to a flat surface, and by the top wall 23 and which has a linear shape extending in the tire radial direction as viewed in the tire width direction, and an edge 24b which is defined by the other part of the side wall 22 and by the top wall 23 and which has an elliptically arcuate shape.

When the rotation direction of the pneumatic tire 1 is the direction indicated by the arrow R, the portion 22a of the side wall 22 corresponding to the flat surface, i.e., the edge 24a having a linear shape comes to the treading side. Accordingly, traction performance further improves. In this case, the portion 22b of the side wall 22 constituted by a curved surface is located on the kicking side. Accordingly, external damage resistance improves by reduction of movement of the protrusion 21 at the time of kicking.

### Fourth Embodiment

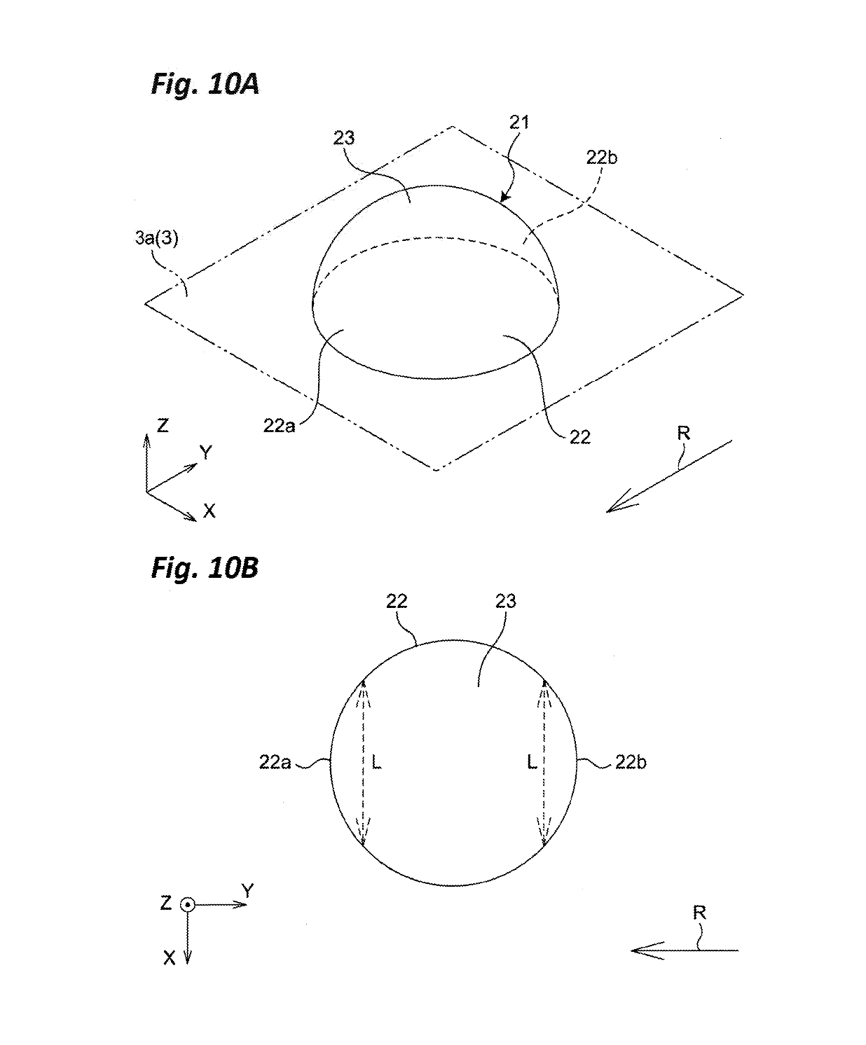

FIGS. 10A and 10B show the protrusion 21 according to a fourth embodiment of the present invention. The protrusion 21 has a semispherical shape. Each of the pair of portions 22a and 22b included in the side wall 22 and facing each other in the tire circumferential direction, and the top wall 23 is a curved surface constituting a part of the semispherical shape. In this case, each of the shapes of the respective portions 22a and 22b as viewed in the tire width direction is arcuate (example of protruding curve). Accordingly, the ground contact length L in the tire radial direction gradually decreases toward the kicking side end of the protrusion 21 in either the case where the rotation direction of the pneumatic tire 1 is the direction indicated by the arrow R or the case where the rotation direction of the pneumatic tire is the direction opposite to the arrow R. Accordingly, movement of the protrusion 21 decreases at the time of kicking. As a result, external damage resistance of the protrusion 21 improves.

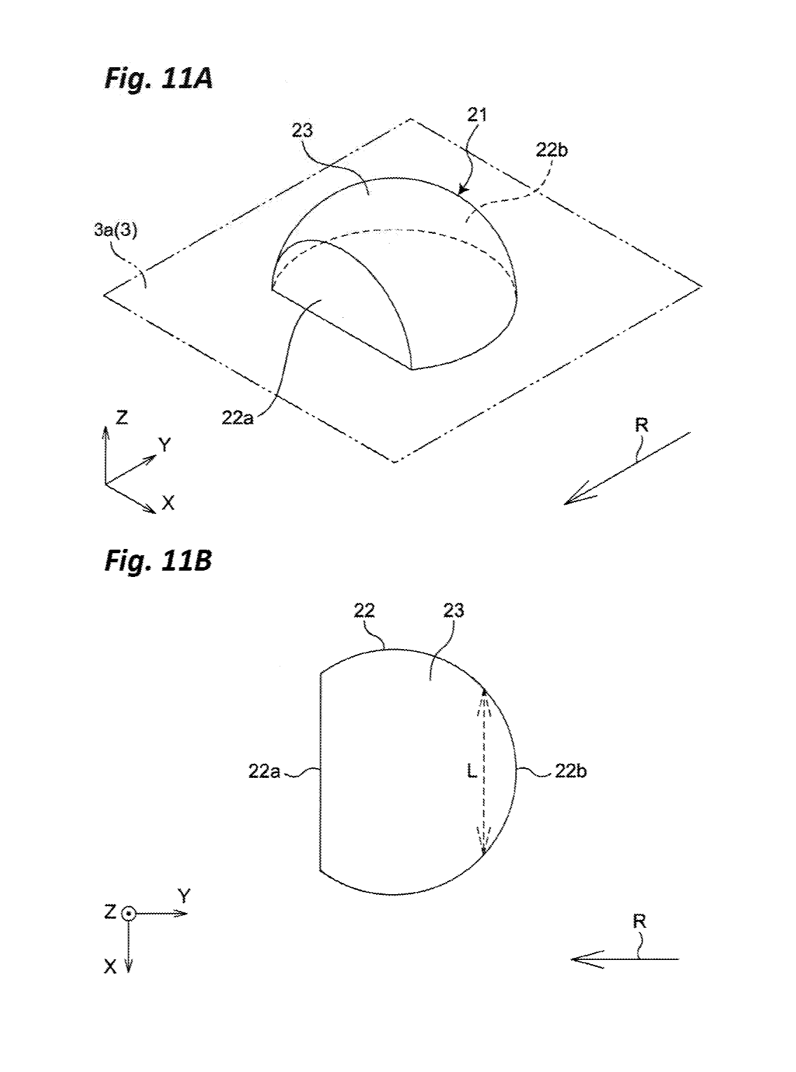

FIGS. 11A and 11B show the protrusion 21 according to a modified example of the fourth embodiment. According to the protrusion 21 in this example, the side wall 22 includes the pair of portions 22a and 22b facing each other in the tire circumferential direction. The one portion 22a is a flat surface extending while crossing the tire circumferential direction and the surface 3a of the buttress portion 3 at right angles, while the remaining portion of the protrusion 21 is semispherical. In other words, each of the other portion 22b of the pair of portions 22a and 22b facing each other in the tire circumferential direction, and the top wall 23 is a part of the semispherical shape.

When the rotation direction of the pneumatic tire 1 is the direction indicated by the arrow R, the portion 22a of the side wall 22 corresponding to the flat surface, i.e., the edge 24a having a linear shape comes to the treading side. Accordingly, traction performance further improves. In this case, the portion 22b of the side wall 22 constituted by a curved surface is located on the kicking side. Accordingly, external damage resistance improves by reduction of movement of the protrusion 21 at the time of kicking.

### Fifth Embodiment

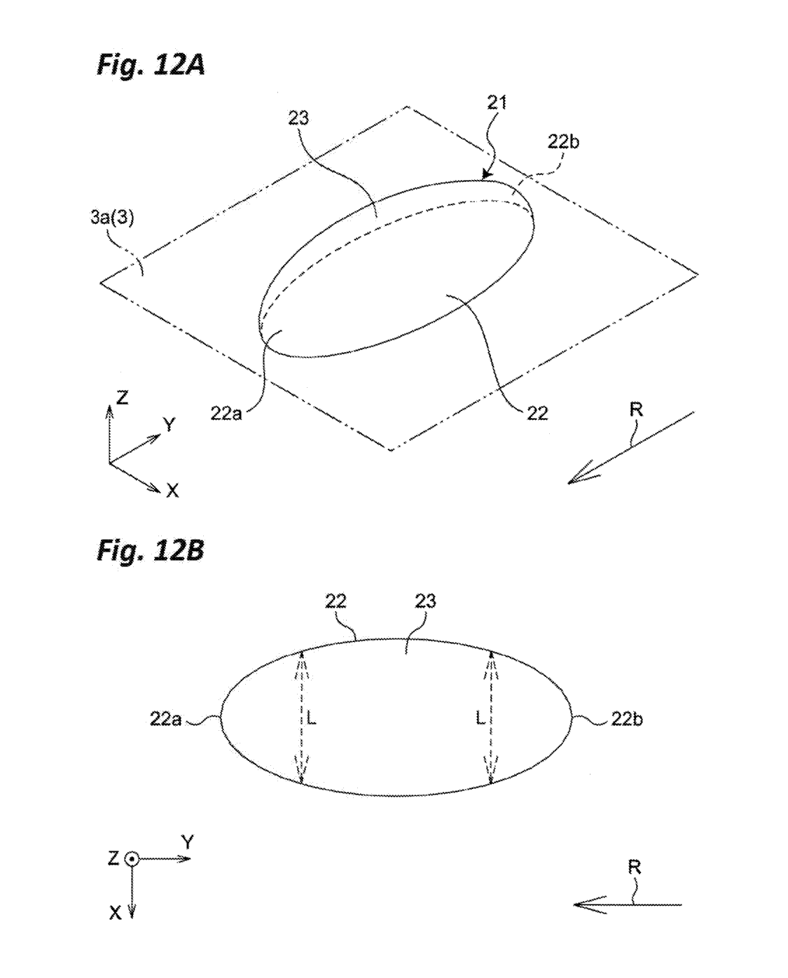

FIGS. 12A and 12B show the protrusion 21 according to a fifth embodiment of the present invention. The protrusion 21 has a semi-elliptically spherical shape. Each of the pair of portions 22a and 22b included in the side wall 22 and facing in the tire circumferential direction, and the top wall 23 has a curved surface constituting a part of the semi-elliptically spherical shape. Accordingly, each of the shapes of the respective portions 22a and 22b as viewed in the tire width direction is elliptically arcuate (example of protruding curve). Accordingly, the ground contact length L in the tire radial direction gradually decreases toward the kicking side end of the protrusion 21 in either the case where the rotation direction of the pneumatic tire 1 is the direction indicated by the arrow R or the case where the rotation direction of the pneumatic tire is the direction opposite to the arrow R. Accordingly, movement of the protrusion 21 decreases at the time of kicking. As a result, external damage resistance of the protrusion 21 improves.

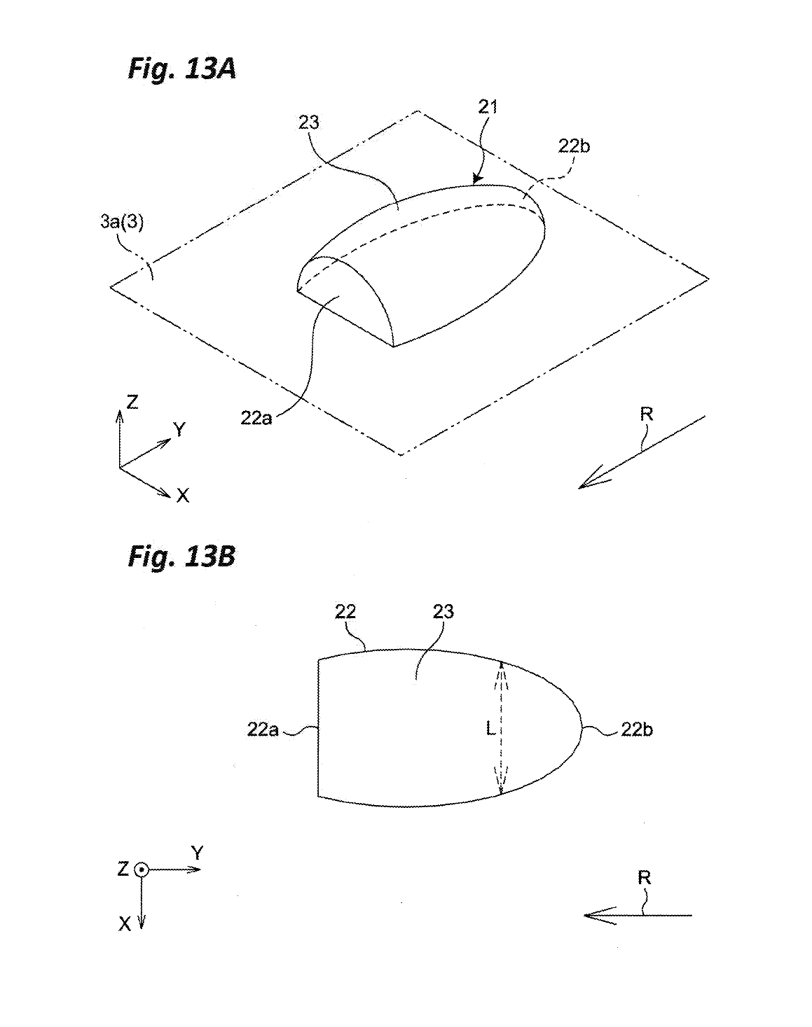

FIGS. 13A and 13B show the protrusion 21 according to a modified example of the fifth embodiment. According to the protrusion 21 in this example, the side wall 22 includes the pair of portions 22a and 22b facing each other in the tire circumferential direction. The one portion 22a is a flat surface extending while crossing the tire circumferential direction and the surface 3a of the buttress portion 3 at right angles, while the remaining portion of the protrusion 21 is semi-elliptically spherical. Accordingly, each of the other portion 22b of the pair of portions 22a and 22b facing each other in the tire circumferential direction, and the top wall 23 is a part of the semi-elliptically spherical shape.

When the rotation direction of the pneumatic tire 1 is the direction indicated by the arrow R, the portion 22a of the side wall 22 corresponding to the flat surface, i.e., the edge 24a having a linear shape comes to the treading side. Accordingly, traction performance further improves. In this case, the portion 22b of the side wall 22 constituted by a curved surface is located on the kicking side. Accordingly, external damage resistance improves by reduction of movement of the protrusion 21 at the time of kicking.

What is claimed is:

1. A pneumatic tire comprising a protrusion provided on a buttress portion, wherein
the protrusion includes
a side wall protruding from a surface of the buttress portion, and
a top wall provided at a distal end of the side wall, and
at least one of a pair of portions included in the side wall and facing each other in a tire circumferential direction constitutes a protruding curve as viewed in a tire width direction.

2. The pneumatic tire according to claim 1, wherein
the side wall has a cylindrical shape, and
the top wall has a circular shape as viewed in the tire width direction.

3. The pneumatic tire according to claim 1, wherein
the side wall has a track-shaped elliptically cylindrical shape, and
the top wall has a track-shaped elliptical shape as viewed in the tire width direction.

4. The pneumatic tire according to claim 1, wherein
the side wall has an elliptically cylindrical shape, and
the top wall has an elliptical shape as viewed in the tire width direction.

5. The pneumatic fire according to claim 1, wherein
the protrusion has a semispherical shape, and
each of the side wall and the top wall is a part of the semi spherical shape.

6. The pneumatic tire according to claim 1, wherein
the protrusion has a semi-elliptically spherical shape, and
each of the side wall and the top wall is a part of the semi-elliptically spherical shape.

7. The pneumatic tire according to claim 1, wherein
one of the pair of portions of the side wall is a part of a cylindrical shape, and
the other of the pair of portions has a flat shape that extends while crossing the tire circumferential direction.

8. The pneumatic tire according to claim 1, wherein
one of the pair of portions of the side wall is a curved surface portion having a track-shaped elliptically cylindrical shape, and
the other of the pair of portions has a flat shape that extends while crossing the tire circumferential direction.

9. The pneumatic tire according to claim 1, wherein
one of the pair of portions of the side wall is a part of an elliptically cylindrical shape, and
the other of the pair of portions has a flat shape that extends while crossing the tire circumferential direction.

10. The pneumatic tire according to claim 1, wherein
one of the pair of portions of the side wall is a part of a semispherical shape, and
the other of the pair of portions has a flat shape that extends while crossing the tire circumferential direction.

11. The pneumatic tire according to claim 1, wherein
one of the pair of portions of the side wall is a part of a semi-elliptically spherical shape, and
the other of the pair of portions has a flat shape that extends while crossing the tire circumferential direction.

12. The pneumatic tire according to claim 1, wherein each of an outer end and an inner end of the protrusion in a tire radial direction is disposed at a height in a range not less than 0.1 and not more than 1.0 times a tire height from an innermost end of the pneumatic tire.

13. The pneumatic tire according to claim 1, further comprising
a block extending from a tread portion to the buttress portion beyond a tread end,
wherein the protrusion is disposed such that an outer end of the protrusion is disposed adjacent to an inner end of the block in a tire radial direction.

14. The pneumatic tire according to claim 13, wherein
the block includes a first block having an edge that is defined by a portion extending in the tire width direction and a portion extending in the tire radial direction, and that is located at a first position,
the block includes a second block having an edge that is defined by a portion extending in the tire width direction and a portion extending in the tire radial direction, and that is located at a second position closer to a center in the tire width direction than the first position is, and
the first block and the second block are alternately arranged in the tire circumferential direction.
